(19) United States
(12) Patent Application Publication
(10) Pub. No.: US 2026/0145452 A1
(43) Pub. Date: May 28, 2026

(54) RECORDING DEVICE

(71) Applicant: SEIKO EPSON CORPORATION, Tokyo (JP)

(72) Inventor: Kenji KOJIMA, FUJIMI-MACHI (JP)

(21) Appl. No.: 19/398,322

(22) Filed: Nov. 24, 2025

(30) Foreign Application Priority Data
Nov. 25, 2024 (JP) 2024-204488

(51) Int. Cl. B41J 29/17; B41J 11/00

(52) U.S. Cl. CPC B41J 29/17; B41J 11/007

(57) ABSTRACT

A recording device 1 includes a transport belt 33 that includes an adhesive layer Ad configured to adhere a fabric P and that transports the fabric P adhered to the adhesive layer Ad; a recording section 60 that performs recording by ejecting pigment ink onto the fabric P being transported; a washing mechanism 100 that washes the adhesive layer Ad; and a control section 5 that controls execution of a first washing mode and a second washing mode, wherein the control section 5, in the first washing mode, supplies a first washing liquid having a characteristic of swelling the adhesive layer Ad to the washing mechanism 100 to cause the washing mechanism 100 to wash the adhesive layer Ad, and, in the second washing mode, supplies a second washing liquid not having the characteristic to the washing mechanism 100 to cause the washing mechanism 100 to wash the adhesive layer Ad.

The present application is based on, and claims priority from JP Application Serial Number 2024-204488, filed Nov. 25, 2024, the disclosure of which is hereby incorporated by reference herein in its entirety.

### BACKGROUND

### 1. Technical Field

The present disclosure relates to a recording device.

### 2. Related Art

In the related art, a recording device that performs printing by ejecting liquid such as ink onto a medium such as paper or a fabric has been known. For example, JP-A-2015-71269 discloses a recording device including a transport belt that transports a recording medium that is a medium, and a washing section that washes the transport belt.

However, the device described in JP-A-2015-71269 has a problem that it is difficult to improve an operation rate. Specifically, when a pigment is used as a color material of ink, a component containing the pigment may deposit to a surface of the transport belt to form a pigment coating. A pigment coating is difficult to remove with washing liquid such as water or a surfactant, and removal of the pigment coating is not disclosed in the above-described device. Removal of a pigment coating requires maintenance work, and there is a possibility that downtime of the device becomes long. That is, there has been a demand for a recording device that shortens downtime due to maintenance work or the like and improves an operation rate.

### SUMMARY

A recording device includes a transport belt that includes an adhesive layer configured to adhere a fabric and that transports the fabric adhered to the adhesive layer; a recording section that performs recording by ejecting pigment ink onto the fabric being transported; a washing mechanism that washes the adhesive layer; and a control section that controls execution of a first washing mode and a second washing mode, wherein the control section, in the first washing mode, supplies a first washing liquid having a characteristic of swelling the adhesive layer to the washing mechanism to cause the washing mechanism to wash the adhesive layer, and, in the second washing mode, supplies a second washing liquid not having the characteristic to the washing mechanism to cause the washing mechanism to wash the adhesive layer.

### BRIEF DESCRIPTION OF THE DRAWINGS

FIG. 1 is a schematic diagram illustrating a configuration of a recording device according to an embodiment.

FIG. 2 is a schematic diagram illustrating a configuration of a washing mechanism.

### DESCRIPTION OF EMBODIMENTS

In the embodiment described below, a recording device 1 used for digital textile printing of a fabric is exemplified and described with reference to the drawings. The application of the recording device of the present disclosure is not limited to textile printing.

In the following drawings, XYZ axes which are coordinate axes orthogonal to each other are given, a direction indicated by each arrow is a +direction, and a direction opposite to the +direction is a −direction. When the recording device 1 is installed on a horizontal surface such as a floor, a —Z direction is a vertical direction. A +Z direction may be referred to as an upward direction, and the —Z direction may be referred to as a downward direction. For convenience of illustration, the size of each member differs from the actual size.

In a transport path of a fabric that is a recording medium, is unwound from an original fabric, is printed, and is wound into a roll, an original fabric side may be referred to as upstream, and a side on which the fabric is wound may be referred to as downstream. Further, a direction in which a fabric is transported from upstream to downstream is defined as a transport direction.

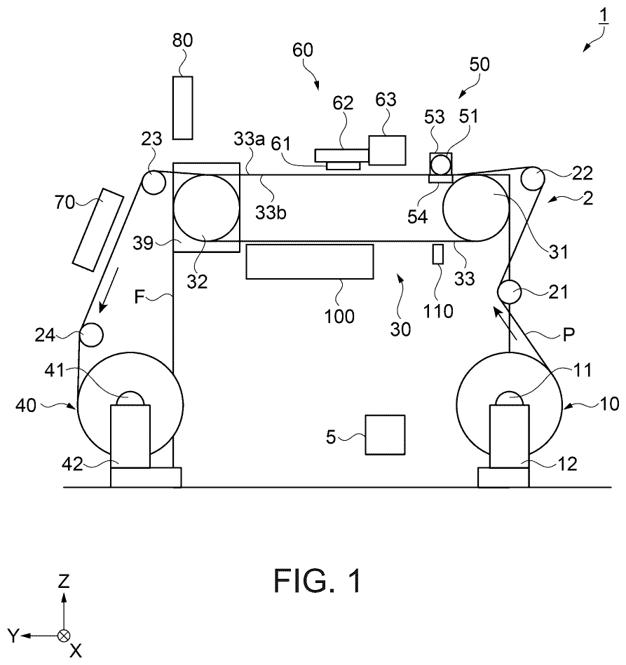

As illustrated in FIG. 1, the recording device 1 according to the present embodiment includes a control section 5, a medium convey section 2, a recording section 60, a drying section 70, a winding section 40, an operation panel 80, and a washing mechanism 100. The recording device 1 also includes a housing (not illustrated). The configurations of the recording device 1 are supported by a frame F.

The recording device 1 causes pigment ink or the like to deposit to a fabric P, and forms an image such as a picture, a photograph, a text, or a pattern on the fabric P to manufacture a printed material. In the description of FIG. 1, a state viewed from a-X direction will be described unless otherwise specified.

The control section 5 is electrically connected to each configuration of the recording device 1 and integrally controls an operation of each configuration. Although details will be described later, the control section 5 particularly controls execution of a first washing mode and a second washing mode in the washing mechanism 100.

The control section 5 includes hardware such as a central processing unit (CPU), a read only memory (ROM), and a random access memory (RAM). The control section 5 executes a predetermined control program by the CPU. The ROM is a nonvolatile storage device and stores a control program executed by the CPU and data processed by the control program. The RAM constitutes a work area of the CPU. The CPU loads a control program read from the ROM or the like into the RAM and executes the loaded control program.

The operation panel 80 is also electrically connected to the control section 5. The operation panel 80 displays various types of information for a user of the recording device 1 and receives various operations and various settings input by the user. The control section 5 controls the recording device 1 also based on information input to the operation panel 80. In the following description, a user of the recording device 1 is also simply referred to as a user.

The operation panel 80 is supported by the frame F via a member (not illustrated) and is arranged above the recording device 1 at an end section in a +Y direction. A user stands in the +Y direction of the recording device 1 and performs various inputs while viewing the operation panel 80. The operation panel 80 is, for example, a touch panel type liquid crystal display. The operation panel 80 may include a physical button in addition to the liquid crystal display.

The medium convey section 2 includes a medium feed section 10, convey rollers 21, 22, 23, and 24, a transport mechanism 30, and the winding section 40. The medium convey section 2 conveys the fabric P along the transport path from upstream to downstream.

The medium feed section 10 includes a feed shaft section 11, bearing sections 12, and a rotation drive section (not illustrated). The feed shaft section 11 has a substantially cylindrical shape and holds a core of an original fabric of the fabric P. The bearing sections 12 detachably and rotatably support both ends of the feed shaft section 11 in a direction along an X-axis.

The rotation drive section is, for example, an electric motor, and rotationally drives the feed shaft section 11. The fabric P is unwound from an original fabric and fed downstream by the rotation of the feed shaft section 11 and a belt rotation roller 32 of the transport mechanism 30 (to be described later).

The fabric P is conveyed from the medium feed section 10, passes through the convey roller 21, and the transport direction is changed to the substantially +Y direction by the convey roller 22. The fabric P is delivered to the transport mechanism 30 from substantially a −Y direction.

Examples of fibers that are the material for fabric P include natural fibers such as cotton, silk, hemp, mohair, wool, and cashmere, regenerated fibers such as rayon and cupra, and synthetic fibers such as nylon, polyester, and polyurethane, in single yarn, double yarn, or blended form. The fabric P is obtained by processing the above-described fibers into a woven fabric or a nonwoven fabric. In order to improve various characteristics of a fabric product produced from the printed fabric P, the fabric P may be subjected to a processing step in advance.

The transport mechanism 30 includes belt rotation rollers 31 and 32, a transport belt 33, and a pressure-bonding section 50.

The transport belt 33 is positioned between the convey roller 22 and the convey roller 23, and transports the fabric P. The transport belt 33 is an endless belt, and is stretched by the belt rotation rollers 31 and 32 in a region including a position facing the recording section 60 in an up and down direction. The transport belt 33 includes an outer peripheral surface 33a and an inner peripheral surface 33b. The outer peripheral surface 33a and the inner peripheral surface 33b are in a front-back relationship. The fabric P can be supported on the outer peripheral surface 33a.

The transport belt 33 includes an adhesive layer (not illustrated). The adhesive layer has an adhesive force to the fabric P, and the fabric P can be adhered to the adhesive layer. The adhesive layer is provided over the entire periphery of the outer peripheral surface 33a. The transport belt 33 is driven to rotate counterclockwise by the belt rotation rollers 31 and 32 in a state where the fabric P is adhered to the adhesive layer. By this, the fabric P is transported in the transport direction. The transport direction of the fabric P in the transport belt 33 is the +Y direction.

In a direction along the X-axis, a width of the transport belt 33 is wider than a width of the fabric P. A direction intersecting the transport direction is referred to as a width direction of the transport belt 33. In the present embodiment, the width direction of the transport belt 33 is a direction along the X-axis.

The belt rotation rollers 31 and 32 are substantially cylindrical rotation members and are paired with each other. The belt rotation rollers 31 and 32 are each rotatable about a rotation shaft along the X-axis. The belt rotation roller 31 and the belt rotation roller 32 are arranged to face each other in a direction along a Y-axis. The belt rotation roller 31 is arranged upstream of the transport mechanism 30 and in the vicinity of the convey roller 22 in the +Y direction. The belt rotation roller 32 is arranged downstream of the transport mechanism 30 and in the vicinity of the convey roller 23 in the —Y direction. A support member that supports the transport belt 33 may be arranged between the belt rotation roller 31 and the belt rotation roller 32.

The belt rotation roller 31 is a driven roller that rotates counterclockwise when the rotation of the belt rotation roller 32 is transmitted via the transport belt 33. The belt rotation roller 31 is rotatably supported by a roller support section (not illustrated).

The belt rotation roller 32 is rotationally driven counterclockwise by a transport drive motor (not illustrated). The transport drive motor is controlled by the control section 5. The belt rotation roller 32 is rotatably supported by a roller support section 39.

The fabric P is delivered from the convey roller 22 to the transport mechanism 30 and is supported on the outer peripheral surface 33a of the transport belt 33 above the belt rotation roller 31. At this time, the fabric P may not be in close contact with the outer peripheral surface 33a.

The outer peripheral surface 33a supports the fabric P from below. The inner peripheral surface 33b is in contact with the belt rotation roller 31 and the belt rotation roller 32. The transport belt 33 is rotationally driven by a frictional force between the inner peripheral surface 33b and the belt rotation roller 32. The belt rotation roller 31 is driven by a frictional force between the inner peripheral surface 33b and the belt rotation roller 31.

In a direction along the X-axis, which is the width direction of the transport belt 33, a width of the adhesive layer on the outer peripheral surface 33a is approximately equal to the width of the transport belt 33. A path of the transport belt 33 from the belt rotation roller 31 to the belt rotation roller 32 is the transport path of the fabric P. A path in which the transport belt 33 is turned back at the belt rotation roller 32 and is directed to the belt rotation roller 31 is defined as a non-transport path. The outer peripheral surface 33a faces upward in the transport path and faces downward in the non-transport path.

The adhesive layer on the outer peripheral surface 33a adheres the fabric P by an adhesive force. The adhesive layer includes an adhesive material having an adhesive force, such as a silicone resin, an acrylic resin, or a urethane resin. In the recording device 1, an acrylic resin is used as a base material of the adhesive layer. Examples of the acrylic resin include known acrylic resins such as polybutyl acrylate.

The pressure-bonding section 50 is arranged in the vicinity of the belt rotation roller 31 in the +Y direction. The pressure-bonding section 50 includes a pressing roller 51, a pair of support sections 53, a heating section 54, and a pair of drive sections (not illustrated). The pressure-bonding section 50 bonds the fabric P and the adhesive layer of the transport belt 33 by pressure bonding, and adheres the fabric P to the adhesive layer.

The pressing roller 51 is a substantially cylindrical rotation member. The pressing roller 51 includes a rotation shaft along the X-axis and is arranged above the transport belt 33. The support sections 53 are arranged at both ends of the pressing roller 51 in a direction along the X-axis. The pressing roller 51 is rotatably supported by the pair of support sections 53. Each of the pair of support sections 53 is supported by the drive section. In a direction along the X-axis, a length of the pressing roller 51 is substantially equal to the width of the transport belt 33.

One of the drive sections is arranged at a position further in a −X direction with respect to the support section 53 that supports an end section of the pressing roller 51 in the −X direction. An other of the drive sections is arranged at a position further in a +X direction with respect to the support section 53 that supports an end section of the pressing roller 51 in the +X direction.

The pair of drive sections moves in the up and down direction by a raising and lowering drive motor (not illustrated) while supporting the pair of support sections 53. Therefore, the pressing roller 51 can be displaced in the up and down direction while being supported by the support sections 53. By this, the strength of a pressing force with which the pressing roller 51 presses the fabric P against the adhesive layer on the outer peripheral surface 33a is adjusted.

Although not illustrated, the pair of drive sections also reciprocates in a direction along the Y-axis while supporting the pair of support sections 53 by driving a guide member and a motor. Therefore, the pressing roller 51 is supported by the support sections 53 and can reciprocate in a direction along the Y-axis.

The heating section 54 heats the transport belt 33. The heating section 54 is arranged below the pressing roller 51 with the transport belt 33 interposed therebetween. An upper surface of the heating section 54 is formed in a substantially flat shape and is in contact with the inner peripheral surface 33b of the lower section of the transport belt 33 in the transport path. The distance of the heating section 54 in a direction along the Y-axis is substantially equal to the distance by which the pressing roller 51 reciprocates in the transport direction and a reverse transport direction. The distance of the heating section 54 in a direction along the X-axis is substantially equal to the width of the transport belt 33 in a direction along the X-axis.

The heating section 54 is, for example, an electric heater. The adhesive layer on the outer peripheral surface 33a of the transport belt 33 is heated by the heating section 54. The adhesive layer is increased in flexibility by heating, and an adhesive force to the fabric P is increased. The heating temperature by the heating section 54 is, for example, 35° C. or more and 60° C. or less on the upper surface of the heating section 54.

In the pressure-bonding section 50, the fabric P is supported on the upper surface of the heating section 54 via the transport belt 33. The heating section 54 heats the transport belt 33, and the pressing roller 51 presses the fabric P against the adhesive layer from above. In parallel with this, the pressing roller 51 reciprocates in the +Y direction and the −Y direction while rotating. The fabric P and the transport belt 33 are sandwiched and pressed between the upper surface of the heating section 54 and the pressing roller 51, so that the fabric P and the outer peripheral surface 33a are in close contact with each other. The fabric P passes through the pressure-bonding section 50 and is transported in the +Y direction while being in close contact with the transport belt 33. Instead of the heating section 54, the pressing roller 51 may have a function of heating the transport belt 33. The heating section 54 may be omitted depending on a type of the fabric P and a characteristic of the adhesive layer.

As a configuration in which the pressing roller 51 has a function of heating the transport belt 33, a following heat roller type is exemplified. The heat roller type includes a support plate having substantially the same shape as the heating section 54, a heat roller having the same shape as the pressing roller 51, the pair of support sections 53, and the pair of drive sections. That is, the heat roller type operates in the same manner as the pressure-bonding section 50 except that a heating function of the heating section 54 is performed by the heat roller.

The recording section 60 faces the outer peripheral surface 33a and the fabric P in the up and down direction in the middle of the transport belt 33 in a direction along the Y-axis. The recording section 60 performs recording by ejecting and depositing pigment ink or the like to the fabric P transported by the transport belt 33. By this, the fabric P is printed. The recording section 60 includes an ejection section 61 that is an inkjet head, a carriage 62, and a guide rail 63.

The guide rail 63 is a structural member extending along the X-axis, and is arranged above the transport mechanism 30. The guide rail 63 supports the carriage 62 so as to be movable in a direction along the X-axis. The carriage 62 is supported by the guide rail 63 and reciprocates in the direction along the X-axis by the driving of a carriage drive motor (not illustrated). The ejection section 61 is attached below the carriage 62, and reciprocates in the direction along the X-axis with respect to the transport belt 33 together with the carriage 62.

The ejection section 61 ejects and deposits pigment ink, functional liquid, and the like to the fabric P supported on the outer peripheral surface 33a and transported. The ejection section 61 includes a nozzle surface (not illustrated) at a position facing downward. The nozzle surface faces the transport belt 33 and the fabric P in the up and down direction. A plurality of nozzle arrays are arranged on the nozzle surface. Each of the plurality of nozzle arrays is composed of a plurality of nozzles. Each of the plurality of nozzle arrays individually ejects a plurality of types of pigment ink exhibiting colors such as cyan, magenta, yellow, and black, and functional liquid to the fabric P. Examples of pigment ink include water-based ink and non-water-based ink. In the present embodiment, water-based pigment ink is applied.

In the ejection section 61, a piezoelectric element is used as an actuator that is a drive unit. The drive unit is not limited to this. The drive unit may include, for example, an electromechanical conversion element that displaces a diaphragm as an actuator by electrostatic attraction, or an electrothermal conversion element that ejects ink as droplets by air bubbles generated by heating.

Although not illustrated, pigment ink and functional liquid are each supplied from an ink tank to the ejection section 61 via an ink pipe. Pigment ink and functional liquid ejected from the ejection section 61 deposit to a surface of the fabric P facing upward.

The fabric P is transported in the +Y direction by the transport belt 33 while the ejection section 61 is reciprocated in the direction along the X-axis. At this time, pigment ink or the like is deposited to the fabric P from the ejection section 61 at a predetermined timing. By this, a desired image or the like is formed on the fabric P.

Functional liquid is specifically softener or pretreatment liquid. Functional liquid is ejected onto the fabric P at the same time as or before or after pigment ink is ejected.

Softener has a function of improving the texture of a fabric product when the printed fabric P is processed into a fabric product such as a garment. Softener is not particularly limited, and a known softening agent or the like can be applied. When softener contains a cationic component or the like, the cationic component may react with a component of pigment ink to generate aggregates. Therefore, it is desirable to avoid contact or mixing of softener with pigment ink.

Pretreatment liquid has a function of aggregating a pigment, a resin, and the like in pigment ink on a surface of the fabric P to improve the color development of a printed material. Such a pretreatment liquid is not particularly limited, and a known treatment agent or the like can be applied. Since pretreatment liquid causes a pigment to aggregate, it is desirable to avoid contact or mixing of pretreatment liquid and pigment ink for purposes other than the intended purpose.

As functional liquid, other functional liquid other than softener and pretreatment liquid may be applied. Examples of other functional liquid include coating liquid that improves the abrasion resistance and the washing fastness of the printed fabric P, and a permeating liquid that assists the permeation of pigment ink into the fabric P.

In the ejection section 61, preliminary ejection is performed in a stage before ejection of pigment ink and functional liquid to the fabric P, in an interval between ejections, and the like. Preliminary ejection is performed for purpose of suppressing drying or adhesion of pigment ink or functional liquid at the gas-liquid interface in each nozzle of the ejection section 61, preventing color mixing after cleaning of each nozzle, and the like. The execution of preliminary ejection is controlled by the control section 5. The timing of performing preliminary ejection, the time interval, amounts of pigment ink and functional liquid to be preliminarily ejected, and the like are appropriately set according to types and characteristics of pigment ink and functional liquid.

The fabric P on which textile printing is performed is further transported in the +Y direction from a position facing the recording section 60. Then, the fabric P is peeled off from the transport belt 33 substantially above the belt rotation roller 32, and is delivered to the convey roller 23 downstream of the belt rotation roller 32.

The transport belt 33 is turned back from the transport path to the non-transport path by the belt rotation roller 32, and moves in the −Y direction in a state where the outer peripheral surface 33a faces downward.

The washing mechanism 100 washes the adhesive layer of the transport belt 33. The washing mechanism 100 is arranged below the transport belt 33 corresponding to the non-transport path, and faces the outer peripheral surface 33a in the up and down direction.

Here, since the adhesive layer is provided, the fabric P is transported in close contact with the adhesive layer, and preliminary ejection is performed, dirt such as pigment ink, lint of the fabric P, and foreign matter are likely to deposit to the adhesive layer on the outer peripheral surface 33a. When the adhesive layer is significantly contaminated, the fabric P may be contaminated when the transport belt 33 rotates and comes into contact with the fabric P before printing again. There is a possibility that an adhesive force of the adhesive layer may be reduced due to dirt.

In particular, a part of pigment ink and functional liquid may pass through the fabric P and reach the adhesive layer, and form a pigment coating on a surface of the adhesive layer. In addition, a fixing resin is added to pigment ink in many cases in order to improve the fixability to the fabric P. These factors may make it easier for pigment coating to form on the adhesive layer. When pretreatment liquid is used as functional liquid, aggregation of a pigment is promoted, and formation of a pigment coating may proceed.

When formation of a pigment coating or deposit of dirt becomes remarkable, an adhesive force of the adhesive layer is reduced, and the transport of the fabric P may be hindered. In such a case, maintenance work such as reattaching the adhesive layer or replacing the transport belt 33 is performed. Since maintenance work such as reattaching the adhesive layer is performed while an operation of the recording device 1 is stopped, this has been a factor in reducing an operation rate of the recording device 1. In contrast, the recording device 1 washes dirt of the adhesive layer by the washing mechanism 100, and reduces the frequency of maintenance work. The washing mechanism 100 will be described in detail later.

A detection section 110 is provided between the washing mechanism 100 and the belt rotation roller 31 in the non-transport path of the transport belt 33. The detection section 110 detects an adhesive force of the adhesive layer of the transport belt 33. The detection section 110 is electrically connected to the control section 5. Information on an adhesive force detected by the detection section 110 is transmitted to the control section 5. The detection section 110 enables monitoring of an adhesive force of the adhesive layer, in other words, a contamination degree of the adhesive layer.

As the detection section 110, a known adhesive force measuring device can be applied. The arrangement of the detection section 110 is not limited to the arrangement between the washing mechanism 100 and the belt rotation roller 31. The detection section of the present disclosure is not limited to an adhesive force measuring device. The detection section of the present disclosure may be, for example, a mechanism that calculates an adhesive force from a peeling angle of the fabric P peeled by the belt rotation roller 32. Alternatively, the detection section of the present disclosure may be a mechanism that calculates an adhesive force from the rotational resistance of the transport drive motor that rotationally drives the belt rotation roller 32.

The transport belt 33 is turned back from the non-transport path to the transport path by the belt rotation roller 31, and moves in the +Y direction in a state where the outer peripheral surface 33a faces upward. In this way, the transport belt 33 rotates counterclockwise.

The convey roller 23 peels the fabric P on which textile printing is performed from the transport belt 33. The fabric P peeled off from the transport belt 33 is transported in the substantially +Y direction, and the transport direction is changed to the substantially downward direction by the convey roller 23. The convey rollers 23 and 24 relay the fabric P to the winding section 40.

The drying section 70 is arranged between the convey roller 23 and the convey roller 24. The drying section 70 dries pigment ink and functional liquid deposited to the fabric P. The drying section 70 includes, for example, an infrared heater. The volatile components contained in pigment ink and functional liquid deposited to the fabric P are volatilized by infrared rays radiated by the infrared heater. By this, droplets of pigment ink and functional liquid are dried, and the fabric P can be wound by the winding section 40. The fabric P passes through the convey roller 24 and advances to the winding section 40.

The winding section 40 is arranged downstream and below the convey roller 24. The winding section 40 collects a printed material that is the printed fabric P. The winding section 40 includes a winding shaft section 41, bearing sections 42, and a rotation drive section (not illustrated). The winding shaft section 41 has a substantially cylindrical shape and winds a printed material in a roll shape. The bearing sections 42 rotatably supports both ends of the winding shaft section 41 in a direction along the X-axis. The winding shaft section 41 is attachable to and detachable from the bearing sections 42. The rotation drive section rotates the winding shaft section 41 counterclockwise. The winding shaft section 41 is rotated by the rotation drive section, and a printed material is wound. As described above, a printed material is manufactured by the recording device 1.

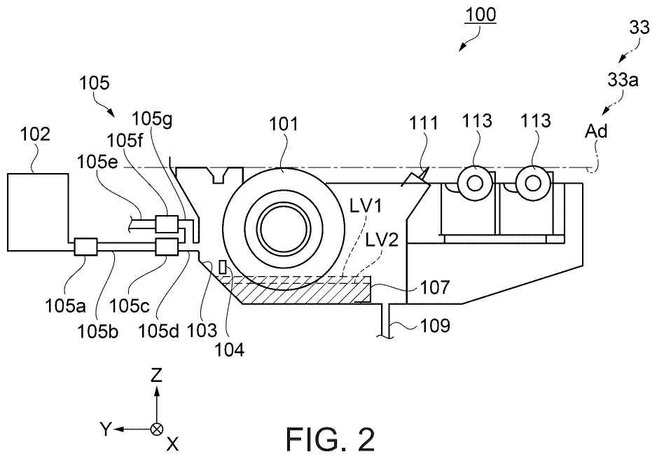

As illustrated in FIG. 2, the washing mechanism 100 includes a washing section 101, a storage tank 102, a washing liquid tank 103, a supply section 105, a defining section 107, a discharge section 109, a wiping section 111, and wiping-off sections 113. As described above, the washing mechanism 100 washes and cleans a pigment coating and dirt depositing to the adhesive layer Ad on the outer peripheral surface 33a of the transport belt 33. In FIG. 2, the transport belt 33 in the non-transport path is indicated by one dot chain line. In the non-transport path, the transport belt 33 moves in the −Y direction.

The washing section 101, the wiping section 111, and the wiping-off sections 113 are positioned at positions where they come into contact with the adhesive layer Ad of the transport belt 33, and are arranged in the above order in the −Y direction. The adhesive layer Ad slides on the washing section 101, the wiping section 111, and the wiping-off sections 113 in this order.

The washing liquid tank 103 has a bathtub shape with an open upper side, and can store liquid for washing the adhesive layer Ad. Liquid referred to here is a first washing liquid, a second washing liquid, and mixed liquid of the first washing liquid and the second washing liquid, which will be described later. The liquid may contain foreign matter such as pieces of a pigment coating or dirt transferred from the adhesive layer Ad by washing. In the following description, liquid stored in the washing liquid tank 103 may be collectively referred to simply as washing liquid.

The washing liquid tank 103 is arranged below the washing section 101. The washing liquid is accumulated at a bottom of the washing liquid tank 103. A lower part of the washing section 101 is immersed in the washing liquid stored in the washing liquid tank 103. In a direction along the X-axis, a width of the washing liquid tank 103 is larger than a width of the washing section 101.

As the washing liquid, the first washing liquid, the second washing liquid, and the mixed liquid of the first washing liquid and the second washing liquid are used. A type of the washing liquid is selected according to a pigment coating and the degree of dirt in the adhesive layer Ad.

Although not illustrated, a liquid discharge mechanism is arranged at a bottom of the washing liquid tank 103. The liquid discharge mechanism discharges the washing liquid accumulated in the washing liquid tank 103. The liquid discharge mechanism is used for replacing the washing liquid, cleaning the washing liquid tank 103, and the like. The liquid discharge mechanism is, for example, an electromagnetic valve, and is opened and closed under the control of the control section 5, and can arbitrarily discharge the washing liquid in the washing liquid tank 103.

The first washing liquid has a characteristic of swelling the adhesive layer Ad. The first washing liquid is, for example, an organic solvent, and is selected according to a type of the adhesive layer Ad and the like. The first washing liquid swells the adhesive layer Ad, and thus, a pigment coating and dirt deposited to a surface of the adhesive layer Ad are lifted up and easily removed. The first washing liquid is applied in a first washing mode. The first washing liquid is also applied to a third washing mode in which washing is performed by mixing the first washing liquid and the second washing liquid in the washing liquid tank 103.

The first washing liquid desirably does not dissolve the adhesive layer Ad. That is, it is desirable that the first washing liquid has a relatively low dissolving power with respect to a resin that is the base material of the adhesive layer Ad. The first washing liquid having a low dissolving power suppresses deterioration of the adhesive layer Ad.

The first washing liquid is not particularly limited, and examples thereof include alcohol-based or glycol ether-based organic solvents such as (2-methoxyethoxy) propanol (also referred to as dipropylene glycol monomethyl ether), 2-butoxyethanol, ethoxylated propoxylated alcohol (C=16 to 18), 3-methoxy-3-methylbutanol, and (R)-4-isopropenyl-1-methylcyclohex-1-ene. The first washing liquid may contain additives such as water and a defoaming agent in addition to the organic solvent.

The first washing liquid desirably does not contain a surfactant. This suppresses foaming by the first washing liquid. Since rinsing is required when a surfactant is used, a rinsing step or mechanism can be omitted.

The second washing liquid does not have a characteristic of swelling the adhesive layer Ad. The second washing liquid is, for example, water. Examples of water include pure water such as ion-exchanged water, ultrafiltered water, reverse osmosis water, and distilled water, and tap water. In the present embodiment, tap water is used as the second washing liquid. The second washing liquid is applied to a second washing mode and the third washing mode.

The second washing liquid may contain an additive such as a disinfectant. From the same viewpoint as the first washing liquid, it is desirable that the second washing liquid does not contain a surfactant.

The supply section 105 supplies the first washing liquid and the second washing liquid to the washing liquid tank 103 of the washing mechanism 100. The supply section 105 includes a liquid feed pump 105a, a pipe 105b, an opening and closing section 105c, and a supply pipe 105d, which supply the first washing liquid. The supply section 105 includes a pipe 105e, an opening and closing section 105f, and a supply pipe 105g, which supply the second washing liquid.

The liquid feed pump 105a, the pipe 105b, the opening and closing section 105c, and the supply pipe 105d, and the pipe 105e, the opening and closing section 105f, and the supply pipe 105g are arranged in the above order toward the washing liquid tank 103, respectively. The supply pipe 105g is connected to a middle of the supply pipe 105d. That is, the second washing liquid flows from the supply pipe 105g into the supply pipe 105d, and is then supplied to the washing liquid tank 103. The first washing liquid and the second washing liquid each flow in the supply section 105 in the order described above.

The storage tank 102 stores the first washing liquid. The storage tank 102 is a liquid accommodation container, and is, for example, a resin tank. The storage tank 102 includes a lid (not illustrated), and the first washing liquid can be replenished to the storage tank 102 by opening the lid. The storage tank 102 is sealed by closing the lid.

Since a user only needs to replenish the storage tank 102 with the first washing liquid, the convenience of the user is improved. Since the storage tank 102 functions as a buffer tank, it is possible to replenish the first washing liquid to the storage tank 102 while consuming the first washing liquid by the washing mechanism 100.

The pipe 105b of the supply section 105 is connected to the storage tank 102 via the liquid feed pump 105a. The liquid feed pump 105a feeds the first washing liquid stored in the storage tank 102 to the pipe 105b. The pipe 105b is connected to the opening and closing section 105c.

The opening and closing section 105c changes a supply amount of the first washing liquid supplied to the washing liquid tank 103. The opening and closing section 105c is connected to the pipe 105b and the supply pipe 105d, and feeds the first washing liquid whose supply amount is adjusted to the washing liquid tank 103 via the supply pipe 105d.

The opening degree of a valve (not illustrated) in the opening and closing section 105c can be arbitrarily changed between full open and full close. The opening degree of the valve of the opening and closing section 105c is controlled by the control section 5. That is, the control section 5 controls the opening and closing section 105c of the supply section 105 to adjust an amount of the first washing liquid supplied to the washing liquid tank 103. This improves the convenience of a user compared to a case where the user manually adjusts a supply amount. A known valve mechanism such as an electromagnetic valve is applied to the valve of the opening and closing section 105c.

The supply pipe 105d connects the opening and closing section 105c and the washing liquid tank 103. The supply pipe 105d is connected to a side wall of the washing liquid tank 103 in the +Y direction, and communicates with the inside of the opening and closing section 105c and the inside of the washing liquid tank 103. As described above, an end of the supply pipe 105g is connected to the supply pipe 105d.

The pipe 105e connects a supply source of the second washing liquid and the opening and closing section 105f. In the present embodiment, since tap water is used as the second washing liquid, the pipe 105e is connected to a tap water faucet via, for example, a flexible hose. The pipe 105e may be connected to a container similar to the storage tank 102, and the second washing liquid such as tap water may be supplied from the container.

The opening and closing section 105f changes a supply amount of the second washing liquid supplied to the washing liquid tank 103. The opening and closing section 105f is connected to the pipe 105e and the supply pipe 105g, and feeds the second washing liquid whose supply amount is adjusted to the supply pipe 105g.

The opening degree of a valve (not illustrated) in the opening and closing section 105f can be arbitrarily changed between full open and full close. The opening degree of the valve of the opening and closing section 105f is controlled by the control section 5. That is, the control section 5 controls the opening and closing section 105f of the supply section 105 to adjust an amount of the second washing liquid supplied to the washing liquid tank 103. The same valve mechanism as that of the opening and closing section 105f is applied to the valve of the opening and closing section 105c.

Here, by adjusting the opening degree of the opening and closing section 105c and the opening degree of the opening and closing section 105f, the first washing liquid and the second washing liquid can be supplied to the washing liquid tank 103 at the same time. Therefore, the concentration of the first washing liquid in the washing liquid can be adjusted.

The supply pipe 105g connects the opening and closing section 105f and the supply pipe 105d. The supply pipe 105g is connected to a middle of the supply pipe 105d, and communicates with the inside of the opening and closing section 105f and the inside of the supply pipe 105d.

The first washing liquid and the second washing liquid supplied from the supply section 105 flow along a side wall of the washing liquid tank 103 in the +Y direction and the like and are accumulated on a bottom of the washing liquid tank 103. The arrangement of the configurations of the supply section 105 described above is an example and is not limited to the above.

The defining section 107 defines the volume of the washing liquid stored in the washing liquid tank 103. The defining section 107 is arranged on a bottom of the washing liquid tank 103 so as to be close to the −Y direction. The defining section 107 is a plate-shaped partition member. The defining section 107 protrudes upward from a bottom of the washing liquid tank 103 along an XZ plane. The washing liquid is stored in a region defined by a side wall and a bottom of the washing liquid tank 103 and the defining section 107.

In FIG. 2, the region is hatched with oblique lines. FIG. 2 illustrates a state in which the washing liquid is at a liquid level Lv1, and the liquid level Lv1 is a liquid level when the washing liquid tank 103 is fully filled with the washing liquid. When the washing liquid is further supplied from the state where the washing liquid is at the liquid level Lv1, the washing liquid climbs over the defining section 107 and overflows in the −Y direction. The overflowing washing liquid is discharged from the discharge section 109 to the outside of the washing liquid tank 103.

The washing liquid discharged from the discharge section 109 may be accommodated in a waste liquid tank or the like, or may be circulated and reused. When the washing liquid is circulated and reused, an aggregation section, a recovery section, a circulation section, and the like are arranged in the above order following the discharge section 109.

In the aggregation section, pigment particles, resin components, and the like contained in pigment ink are aggregated. Pigment particles are dispersed in water by an anionic group introduced to a particle surface or by a dispersion resin having an anionic group added to the pigment particles. Therefore, when a cationic component is added, the dispersion stability is inhibited, and pigment particles and a dispersion resin are likely to aggregate. Therefore, in the aggregation section, a cationic component or the like is added to aggregate pigment particles and a dispersion resin.

In the recovery section, foreign matters such as a pigment coating and dust, and aggregated pigment particles, a dispersion resin, and the like are recovered and removed by filtration.

The circulation section is, for example, a pump for liquid feeding, and supplies the washing liquid from which foreign matters, pigment particles, and the like are removed to the washing liquid tank 103 or the storage tank 102 according to components of the washing liquid. The aggregation section, the recovery section, and the circulation section may be arranged in the above-described liquid discharge mechanism to reuse the washing liquid stored in the washing liquid tank 103.

The washing mechanism 100 operates either in a state where the washing liquid is at the liquid level Lv1 or in a state where the washing liquid is at a liquid level Lv2 lower than the liquid level Lv1. A lower part of the washing section 101 is immersed in the washing liquid in the washing liquid tank 103 even at the liquid level Lv2. When washing is performed at the liquid level Lv1, the first washing liquid or the second washing liquid may be continuously supplied and poured. By this, foreign matters and the like in the washing liquid tank 103 are discharged beyond the defining section 107 together with the washing liquid. Therefore, in the washing liquid stored in the washing liquid tank 103, the foreign matters are reduced and the cleanliness of the washing liquid is maintained. In contrast, at the liquid level Lv2, the supply of the first washing liquid and the second washing liquid may be stopped, and washing may be performed only with the washing liquid stored in the washing liquid tank 103.

Since the liquid level Lv1 of the maximum amount of the washing liquid stored in the washing liquid tank 103, that is, the upper limit of the liquid level is defined by the defining section 107, the washing liquid is prevented from being stored in the washing liquid tank 103 more than necessary. By supplying the washing liquid to the washing liquid tank 103, the washing liquid is caused to overflow, and the cleanliness of the stored washing liquid can be maintained.

A liquid level measuring section 104 that measures the height of a liquid surface of the washing liquid stored in the washing liquid tank 103, that is, a liquid level is arranged in the washing liquid tank 103. The liquid level measuring section 104 is a known liquid level sensor of a contact type, a non-contact type, or the like. A position of a liquid surface including the liquid levels Lv1 and Lv2 is measured by the liquid level measuring section 104. The liquid level measuring section 104 is electrically connected to the control section 5. Information on the height of a liquid surface measured by the liquid level measuring section 104 is transmitted to the control section 5. The control section 5 can control the supply section 105 and the above-described liquid discharge mechanism to adjust a position of a liquid surface including the liquid levels Lv1 and Lv2.

The composition of the washing liquid stored in the washing liquid tank 103, that is, the concentration of the first washing liquid may be adjusted by adding water to the first washing liquid in the storage tank 102, or may be adjusted by the ratio between the first washing liquid and the second washing liquid supplied from the supply section 105. The first washing liquid may be used as the washing liquid in an undiluted state.

The washing section 101 washes the adhesive layer Ad of the transport belt 33. The washing section 101 is a substantially cylindrical brush having a central axis along the X-axis. Although not illustrated, the washing section 101 is supported by a support member and is rotated counterclockwise about the central axis by a drive motor.

The washing section 101 comes into contact with the adhesive layer Ad while rotating in a state where the washing liquid is deposited, and scrapes off dirt such as a pigment coating. At this time, the control section 5 selects and performs the first washing mode, the second washing mode, and the like. The first washing mode is performed when the deposit of a pigment coating or dirt is significant in the adhesive layer Ad. The second washing mode is performed when the deposit of a pigment coating or dirt is slight or almost none in the adhesive layer Ad. The third washing mode may be performed under an intermediate situation between the first washing mode and the second washing mode.

Foreign matters such as a pigment coating and dirt is transferred from the adhesive layer Ad to the washing section 101 by the rotation of the washing section 101. After sliding on the adhesive layer Ad, the washing section 101 rotates and is immersed in the washing liquid in the washing liquid tank 103, and foreign matters scraped off from the adhesive layer Ad is transferred to the washing liquid to clean the adhesive layer Ad. The rotation of the transport belt 33 causes a region of the adhesive layer Ad that has slid against the washing section 101 to advance to the wiping section 111.

The wiping section 111 slides on the adhesive layer Ad to scrape off the washing liquid or the like depositing to the adhesive layer Ad. The wiping section 111 is a substantially plate-shaped rubber member. The washing liquid scraped off from a surface of the adhesive layer Ad falls downward and is discharged from the discharge section 109. The rotation of the transport belt 33 causes a region of the adhesive layer Ad that has slid against the wiping section 111 to advance to the wiping-off sections 113.

The wiping-off sections 113 absorb and remove minute amounts of the washing liquid remaining on the adhesive layer Ad. The wiping-off section 113 is a substantially cylindrical sponge member having a central axis along the X-axis. A plurality of wiping-off sections 113 are arranged. In a direction along the X-axis, a width of each wiping-off section 113 is shorter than a width of the adhesive layer Ad. When viewed from above, the wiping-off sections 113 are arranged in a staggered manner. When the adhesive layer Ad passes through the plurality of wiping-off sections 113, the entire region of the adhesive layer Ad in a direction along the X-axis slides on any one of the wiping-off sections 113.

Each wiping-off section 113 is rotated counterclockwise by an electric motor (not illustrated). By the rotation of the transport belt 33, a region of the adhesive layer Ad that has slid on the wiping-off sections 113 passes through the detection section 110 and turns back from the non-transport path to the transport path. As described above, the adhesive layer Ad of the transport belt 33 is washed.

Next, control of the washing conditions in the washing mechanism 100 by the control section 5 will be described. In the following description, reference is made to FIGS. 1 and 2.

In the first washing mode, the control section 5 supplies the first washing liquid from the supply section 105 to the washing liquid tank 103, and causes the washing mechanism 100 to wash the adhesive layer Ad. In the second washing mode, the control section 5 supplies the second washing liquid from the supply section 105 to the washing liquid tank 103, and causes the washing mechanism 100 to wash the adhesive layer Ad. Further, in the third washing mode, the control section 5 supplies the first washing liquid and the second washing liquid from the supply section 105 to the washing liquid tank 103 to wash the adhesive layer Ad.

The washing power for a pigment coating or the like deposited to the adhesive layer Ad is proportional to the concentration of a component that is contained in the first washing liquid and that swells the adhesive layer Ad. That is, the first washing mode has a higher washing power than the second washing mode. The third washing mode has a lower washing power than the first washing mode and a higher washing power than the second washing mode. The washing mechanism 100 selectively uses the first washing mode, the second washing mode, and the third washing mode according to the degree of dirt of a pigment coating or the like.

The washing mechanism 100 may always wash the transport belt 33 during an operation of the recording device 1 for manufacturing a printed material. The washing mechanism 100 may perform washing before the recording device 1 starts the manufacture of a printed material or after the manufacture is completed. In the present embodiment, the washing mechanism 100 continuously washes the transport belt 33 during an operation of the recording device 1. Note that, in the recording device 1, since an operation is normally started from a state where the adhesive layer Ad is relatively clean, the control section 5 first starts washing in the second washing mode.

The control section 5 executes the first washing mode based on the fact that an adhesive force of the adhesive layer Ad detected by the detection section 110 is equal to or less than a threshold. That is, the first washing mode is executed in response to the reduction in an adhesive force of the adhesive layer Ad. The threshold is, for example, 60% when an initial adhesive force of the adhesive layer Ad is 100%.

As formation of a pigment coating or dirt progresses on the adhesive layer Ad, an adhesive force gradually decreases. Therefore, the first washing mode is automatically executed according to the degree of a pigment coating and a contamination degree. This suppresses deterioration of the adhesive layer Ad, and can further improve an operation rate of the recording device 1. Since the first washing mode is automatically executed, the convenience of a user is improved.

The control section 5 can execute the first washing mode instead of the second washing mode during a recording operation in which the recording device 1 performs recording on the fabric P, that is, during the manufacture of the printed material. That is, the second washing mode can be switched to the first washing mode during an operation of the recording device 1. The switching is performed in accordance with a detection result of the detection section 110 or an instruction from a user. For the switching, the washing liquid may be switched from the second washing liquid to the first washing liquid by using the above-described discharge mechanism.

Formation of a pigment coating and the deposit of dirt progress during a recording operation. Therefore, by executing the first washing mode during a recording operation, a pigment coating is easily removed without being grown. This can further improve an operation rate of the recording device 1.

The control section 5 stops the first washing mode based on the fact that an adhesive force of the adhesive layer Ad detected by the detection section 110 is equal to or greater than a threshold. That is, in response to the improvement of an adhesive force of the adhesive layer Ad by the first washing mode, the first washing mode is stopped and the washing mode is switched to the second washing mode. The threshold is, for example, 90% when an initial adhesive force of the adhesive layer Ad is 100%. For the switching, the washing liquid may be switched from the first washing liquid to the second washing liquid by using the above-described discharge mechanism.

When a pigment coating and dirt of the adhesive layer Ad are removed, an adhesive force is recovered. By stopping the first washing mode when an adhesive force is recovered, the first washing mode is executed as necessary and sufficient, and waste of the first washing liquid can be suppressed. Note that in a case where the recording device 1 performs a recording operation even after the first washing mode is stopped, the second washing mode is performed.

Execution and switching of the first washing mode and the second washing mode are automatically performed by the control section 5 based on the change in an adhesive force of the adhesive layer Ad. In addition, a user may arbitrarily switch between the first washing mode and the second washing mode via the operation panel 80. The timing of washing and the washing mode may be selectable by a user.

When switching from the first washing mode to the second washing mode, the third washing mode may be performed first. The third washing mode may be performed when the second washing mode is switched to the first washing mode. The third washing mode is executed according to a detection result of the detection section 110 or an instruction from a user.

Although a method of changing the washing mode according to an adhesive force has been described above, the present disclosure is not limited thereto. The washing mode may be changed by the control section 5 according to the elapsed time for which each washing mode is performed. For example, the following method is specifically mentioned.

First, after a predetermined time has elapsed from the start of a recording operation, the washing mode is switched to the first washing mode. As described above, the second washing mode is basically performed at the start of a recording operation. At this time, the predetermined time is, for example, 30 minutes.

Next, after the elapsed time from execution of the first washing mode has elapsed, for example, 30 minutes, the washing mode may be switched to the second washing mode. Alternatively, the washing mode may be switched to the third washing mode after, for example, 30 minutes have elapsed since the first washing mode was performed. Alternatively, the first washing mode may be continuously performed even after 30 minutes have elapsed.

Note that a user can select whether to change the washing mode according to an adhesive force or the elapsed time before the start of a recording operation, after the end of the recording operation, and at any timing during the recording operation.

In the first washing mode, the control section 5 is capable of supplying the first washing liquid to the washing liquid tank 103 and also supplying the second washing liquid to the washing liquid tank 103. That is, the second washing liquid may be added during washing in the first washing mode, and the washing may be performed in the third washing mode. Since the first washing liquid and the second washing liquid are mixed and used, the third washing mode in which the mixing ratio of the first washing liquid and the second washing liquid is changed according to the degree of a pigment coating and the contamination degree can be applied.

In the first washing mode, the control section 5 discharges the washing liquid, which is liquid accumulated in the washing liquid tank 103, from the discharge mechanism, and then supplies the first washing liquid from the supply section 105 to the washing liquid tank 103. Next, the control section 5 washes the adhesive layer Ad in a state where the first washing liquid has accumulated at the liquid level Lv1 or the liquid level Lv2.

The washing liquid accumulated in the washing liquid tank 103 may contain a pigment coating and dirt removed from the adhesive layer Ad. Therefore, these are discharged and then the clean first washing liquid is accumulated to perform the first washing mode. This makes it easier to remove a pigment coating and dirt of the adhesive layer Ad, and deterioration of the adhesive layer Ad is further suppressed, so that an operation rate of the recording device 1 can be further improved.

In the first washing mode, the control section 5 can further supply the first washing liquid from the supply section 105 to the washing liquid tank 103 when washing the adhesive layer Ad after the first washing liquid has accumulated in the washing liquid tank 103. At this time, when washing is started, the first washing liquid is desirably at the liquid level Lv1. Since the clean first washing liquid is additionally supplied, the first washing mode is performed while causing the washing liquid to overflow from the washing liquid tank 103. This improves the washing power of the first washing liquid for the adhesive layer Ad.

The additional supply of the first washing liquid during execution of the first washing mode as described above is performed when the deposit of the pigment coating or dirt to the adhesive layer Ad is severe and the decrease in an adhesive force of the adhesive layer Ad is particularly significant. When an adhesive force is not so reduced, the first washing liquid is not additionally supplied, and the washing liquid is supplied at the liquid level Lv2 at which the washing liquid does not overflow from the washing liquid tank 103.

According to the present embodiment, the following effects can be obtained.

Downtime due to maintenance work or the like can be shortened, and an operation rate of the recording device 1 can be improved. Specifically, in the first washing mode, the adhesive layer Ad is swelled by the first washing liquid, and thus a pigment coating and dirt are lifted from the adhesive layer Ad and are easily removed. This reduces the frequency of maintenance work such as replacement of the adhesive layer Ad and replacement of the transport belt 33, and shortens downtime of the recording device 1. Therefore, it is possible to provide the recording device 1 that improves an operation rate.

In the second washing mode, washing is performed with a second washing liquid that does not swell the adhesive layer Ad. The second washing mode is for a minor pigment coating or dirt. The first washing mode and the second washing mode can be used properly according to the degree of a pigment coating and dirt. This reduces an amount of the first washing liquid used and improves the convenience of a user.

Hereinafter, contents derived from the embodiment will be described.

A recording device includes a transport belt that includes an adhesive layer configured to adhere a fabric and that transports the fabric adhered to the adhesive layer; a recording section that performs recording by ejecting pigment ink onto the fabric being transported; a washing mechanism that washes the adhesive layer; and a control section that controls execution of a first washing mode and a second washing mode, wherein the control section, in the first washing mode, supplies a first washing liquid having a characteristic of swelling the adhesive layer to the washing mechanism to cause the washing mechanism to wash the adhesive layer, and, in the second washing mode, supplies a second washing liquid not having the characteristic to the washing mechanism to cause the washing mechanism to wash the adhesive layer.

According to this configuration, it is possible to improve an operation rate of the recording device by shortening downtime due to maintenance work or the like. Specifically, in the first washing mode, the adhesive layer is swelled by the first washing liquid, and thus a pigment coating is lifted from the adhesive layer and is easily removed. This reduces the frequency of maintenance work such as replacement of the adhesive layer and replacement of the transport belt, and shortens downtime of the recording device. Therefore, it is possible to provide a recording device that improves an operation rate.

In the second washing mode, washing is performed with the second washing liquid that does not swell the adhesive layer. The second washing mode is for dirt such as a pigment coating or dust. The first washing mode and the second washing mode can be used properly according to the degree of a pigment coating and dirt. This can improve the convenience of a user.

The above-described recording device further includes a storage tank in which the first washing liquid is stored and a supply section that is connected to the storage tank and that supplies the first washing liquid to the washing mechanism.

According to this configuration, a user only needs to replenish the storage tank with the first washing liquid, and thus the convenience of the user is improved. Since the storage tank functions as a buffer tank, it is possible to replenish the first washing liquid to the storage tank even during execution of the first washing mode.

In the above-described recording device, the control section controls the supply section to adjust a supply amount of the first washing liquid supplied to the washing mechanism.

According to this configuration, the convenience of a user is improved as compared with a case where a supply amount is manually adjusted.

In the above-described recording device, the washing mechanism includes a washing liquid tank configured to store liquid and in the first washing mode, the control section supplies the first washing liquid to the washing liquid tank after discharging liquid accumulated in the washing liquid tank, and washes the adhesive layer in a state where the first washing liquid has accumulated in the washing liquid tank.

According to this configuration, liquid accumulated in the washing liquid tank may contain a pigment coating of the adhesive layer and dirt. Since these are discharged and the adhesive layer is washed with the clean first washing liquid, a pigment coating and dirt on the adhesive layer are easily removed. This can further suppress deterioration of the adhesive layer and further improve an operation rate.

In the above-described recording device, the control section is configured to, in the first washing mode, further supply the first washing liquid to the washing liquid tank when the adhesive layer is washed after the first washing liquid has accumulated in the washing liquid tank.

According to this configuration, since the clean first washing liquid is additionally supplied, the washing power of the first washing liquid with respect to the adhesive layer can be improved.

In the above-described recording device, the control section is configured to execute the first washing mode during a recording operation of performing recording on the fabric.

According to this configuration, formation of a pigment coating starts during a recording operation. Therefore, the pigment coating is easily removed by executing the first washing mode during the recording operation. This can further improve an operation rate of the recording device.

In the above-described recording device, in the first washing mode, the control section is configured to supply the first washing liquid to the washing liquid tank and to supply the second washing liquid to the washing liquid tank.

According to this configuration, since the first washing liquid and the second washing liquid can be mixed and used, the mixing ratio of the first washing liquid and the second washing liquid can be changed according to the degree of a pigment coating or the contamination degree.

The above-described recording device further includes a detection section that detects an adhesive force of the adhesive layer, wherein the control section executes the first washing mode based on the adhesive force detected by the detection section becoming equal to or less than a threshold.

According to this configuration, in the adhesive layer, when formation of a pigment coating or dirt progresses, an adhesive force gradually decreases. Therefore, the first washing mode is automatically executed according to the degree of a pigment coating and a contamination degree. This can suppress deterioration of the adhesive layer, and further improve an operation rate. Since the first washing mode is automatically executed, the convenience of a user is improved.

The above-described recording device further includes a detection section that detects an adhesive force of the adhesive layer, wherein the control section stops the first washing mode based on the adhesive force detected by the detection section becoming equal to or greater than a threshold.

According to this configuration, when a pigment coating or dirt of the adhesive layer is removed, an adhesive force is recovered. By stopping the first washing mode when an adhesive force is recovered, the first washing mode is executed as necessary and sufficient, and waste of the first washing liquid and the like can be suppressed.

In the above-described recording device, the first washing liquid does not contain a surfactant.

According to this configuration, foaming due to the first washing liquid is suppressed. Since rinsing is required when a surfactant is used, a rinsing step or mechanism can be omitted.

What is claimed is:

1. A recording device comprising:
a transport belt that includes an adhesive layer configured to adhere a fabric and that transports the fabric adhered to the adhesive layer;
a recording section that performs recording by ejecting pigment ink onto the fabric being transported;
a washing mechanism that washes the adhesive layer; and
a control section that controls execution of a first washing mode and a second washing mode, wherein
the control section, in the first washing mode, supplies a first washing liquid having a characteristic of swelling the adhesive layer to the washing mechanism to cause the washing mechanism to wash the adhesive layer, and, in the second washing mode, supplies a second washing liquid not having the characteristic to the washing mechanism to cause the washing mechanism to wash the adhesive layer.

2. The recording device according to claim 1, further comprising:
a storage tank in which the first washing liquid is stored and
a supply section that is connected to the storage tank and that supplies the first washing liquid to the washing mechanism.

3. The recording device according to claim 2, wherein
the control section controls the supply section to adjust a supply amount of the first washing liquid supplied to the washing mechanism.

4. The recording device according to claim 1, wherein
the washing mechanism includes a washing liquid tank configured to store liquid and
in the first washing mode, the control section supplies the first washing liquid to the washing liquid tank after discharging liquid accumulated in the washing liquid tank, and washes the adhesive layer in a state where the first washing liquid has accumulated in the washing liquid tank.

5. The recording device according to claim 4, wherein
the control section is configured to, in the first washing mode, further supply the first washing liquid to the washing liquid tank when the adhesive layer is washed after the first washing liquid has accumulated in the washing liquid tank.

6. The recording device according to claim 1, wherein
the control section is configured to execute the first washing mode during a recording operation of performing recording on the fabric.

7. The recording device according to claim 4, wherein
in the first washing mode, the control section is configured to supply the first washing liquid to the washing liquid tank and to supply the second washing liquid to the washing liquid tank.

8. The recording device according to claim 1, further comprising:
a detection section that detects an adhesive force of the adhesive layer, wherein
the control section executes the first washing mode based on the adhesive force detected by the detection section becoming equal to or less than a threshold.

9. The recording device according to claim 1, further comprising:
a detection section that detects an adhesive force of the adhesive layer, wherein
the control section stops the first washing mode based on the adhesive force detected by the detection section becoming equal to or greater than a threshold.

10. The recording device according to claim 1, wherein
the first washing liquid does not contain a surfactant.
